(19) United States
(12) Patent Application Publication
(10) Pub. No.: US 2008/0189357 A1
(43) Pub. Date: Aug. 7, 2008

(54) COMMUNITY JOURNALING USING MOBILE DEVICES

(75) Inventors: Archana Prasad, Bangalore (IN); Sean O. Blagsvedt, Bangalore (IN); Vibhore Goyal, Bangalore (IN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/760,591

(22) Filed: Jun. 8, 2007

(30) Foreign Application Priority Data
Feb. 2, 2007 (IN) IN/217/DEL2007

(51) Int. Cl. G06F 15/16

(52) U.S. Cl. 709/203

(57) ABSTRACT

A community journaling system is described. In various embodiments, the community journaling system can receive a message containing a journal entry and a command to post the journal entry to a journal, identify a sender of the received message, determine whether the journal entry should be posted to the journal, and when the journal entry should be posted, convert the journal entry into a journal format that can be posted to the journal, cause the converted journal entry to be posted to the journal, and provide the identification of the sender in association with the posted journal entry.

### CROSS-REFERENCE TO RELATED APPLICATION

This patent application claims the benefit of commonly assigned Indian Provisional Patent Application Serial No. IN/217/DEL/2007, entitled “Community Journaling Using Mobile Devices,” filed on Feb. 2, 2007, which is incorporated herein in its entirety by reference.

### BACKGROUND

Short Message Service (“SMS”) is a very popular mechanism that mobile telephone users employ to send electronic messages to others. SMS is often used by users of older mobile telephone technology, such as mobile phones that are not enabled with General Packet Radio Service (“GPRS”). Mobile telephones that are enabled with GPRS can provide advanced digital features, such as Internet browsing, but older mobile telephones that do not provide GPRS cannot provide these advanced digital features. GPRS is unavailable in many areas and very expensive for some people in other areas.

Many Internet users participate in Web Logs (“blogs”). Blogs are user-generated Web sites in which journal entries can be made. People who participate in blogs by posting journal entries are referred to as “bloggers.” Generally, a blog has a limited number of bloggers and many readers, who are referred to as subscribers. Subscribers often expect bloggers to update their blogs regularly—sometimes even daily.

So that mobile telephone users can post entries in blogs, several SMS-to-blog services exist. To use these SMS-to-blog services, mobile telephone users key in SMS messages using their mobile telephone keypads and send the message to a specified telephone number. An SMS-to-blog service receives the SMS messages sent to such telephone numbers and posts the messages to a specified blog. However, such SMS-to-blog services do not offer their users much flexibility.

### SUMMARY

A community journaling system is described. The community journaling system enables users of mobile devices to share journal entries, such as by using a blog service or other data communications service. The blog service enables multiple users to create and maintain blogs. The mobile devices can be small, portable devices (e.g., conventional mobile telephones) that support simple messaging, such as SMS. Bloggers and subscribers can use the community journaling system to interact with various blog services or other data communications services using their mobile devices. Bloggers can post journal entries to various blogs to which they have access and subscribers can read journal entries from blogs to which they subscribe. The community journaling system can function with virtually any blog service and mobile telephone network service provider. The community journaling system can receive a message containing a journal entry and a command to post the journal entry to a journal, identify a sender of the received message, determine whether the journal entry should be posted to the journal, and when the journal entry should be posted, convert the journal entry into a journal format that can be posted to the journal, cause the converted journal entry to be posted to the journal, and provide the identification of the sender in association with the posted journal entry.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an environment in which the community journaling system operates in some embodiments.

FIG. 2 is a flow diagram illustrating a routine invoked by a component of the community journaling system in some embodiments.

FIG. 3 is a flow diagram illustrating a navigation menu structure the community journaling system may send to users, such as via SMS, in some embodiments.

FIGS. 4-8 are user interface diagrams illustrating Web interfaces associated with the community journaling system in various embodiments.

FIG. 9 is a flow diagram illustrating a routine invoked by a component of the community journaling system in some embodiments.

### DETAILED DESCRIPTION

A community journaling system is described. In various embodiments, the community journaling system enables users of mobile devices to share journal entries, such as by using a blog service or other data communications service. A journal entry can include text, audio, video, images, or any multimedia content that one user (e.g., a blogger) may want to share with other users (e.g., subscribers). The blog service enables multiple users to create and maintain blogs. The mobile devices can be small, portable devices (e.g., conventional mobile telephones) that support simple messaging, such as SMS. Bloggers and subscribers can use the community journaling system to interact with various blog services or other data communications services using a mobile device. Bloggers can post journal entries to various blogs to which they have access and subscribers can read journal entries from blogs to which they subscribe. The community journaling system can receive a message containing a journal entry and a command to post the journal entry to a journal, identify a sender of the received message, determine whether the journal entry should be posted to the journal, and when the journal entry should be posted, convert the journal entry into a journal format that can be posted to the journal, cause the converted journal entry to be posted to the journal, and provide the identification of the sender in association with the posted journal entry. The community journaling system can function with virtually any blog service and mobile telephone network service provider. In some embodiments, the community journaling system includes an SMS computing device. The SMS computing device can be a general use (or special-purpose) computing device that is connected to both a mobile device carrier network (e.g., using an SMS port connected via a mobile device, SIM daughter-card with a radio, etc.) and to a data communications network, such as the Internet. Users can employ their mobile devices to send an SMS message to the SMS computing device. The SMS computing device may be associated with a mobile telephone number and users can indicate this phone number as the destination for the SMS message. Upon receiving an SMS message, software executing on the SMS computing device can determine whether the SMS message is from a registered user. If so, the executing software can parse the SMS message to determine whether the SMS message contains a command. If the SMS message contains a command, the software can invoke a function associated with the command, such as to post a blog journal entry, provide menu commands, provide a blog entry for a subscriber user to read, or take other action. If the SMS message is not from a registered user, the software may send a responsive SMS message to the sender indicating how to subscribe and/or register.

In various embodiments, users of the community journaling system can employ mobile devices to post to their own blogs; read the latest posts on their own blogs; post to a blog; read the latest posts on blogs; subscribe and unsubscribe to blogs for the latest journal entries; post and read blogs owned by people in their social networks; subscribe to posts from specific bloggers or posts made for identified mobile phone numbers; receive alerts from people in their social networks (e.g., relating to “events'”) marked on a community calendar; register, set up, and customize blog-related options from their SMS-enabled phones, and so forth.

The community journaling system in some embodiments can enable menu-driven navigation of blogs using SMS. Using the menus, users can view multiple blogs, retrieve a specified number of blog entries at a time, etc. The community journaling system can provide a menu using SMS messages. As an example, the community journaling system may provide numbers or letters associated with menu or navigation commands. When the user responds with an identified number or letter, the community journaling system can take an indicated action. As an example, the community journaling system may associate “1” or “R” with a “read” command.

The community journaling system in some embodiments may associate a time-based session with phone numbers associated with mobile devices that send SMS messages to the community journaling system. As an example, the community journaling system may associate a session with a mobile device until the user of the mobile device sends a quit (or goodbye) SMS message or the session times out, such as after an hour. During a session, the community journaling system can maintain contextual information so that it can determine what commands to associate with various numbers or letters that are sent as commands in SMS messages the system receives. A session begins when a user first sends a command to the community journaling system and expires after a period of inactivity. When the session expires, the user may be returned to a particular point (e.g., a top menu). When the user sends some commands (e.g., “R” for read), the community journaling system may still be able to take an appropriate action, such as to send the latest blog, whether or not a session has been established or has expired.

The community journaling system in some embodiments enables community blogging. Conventional blogs enable specified individuals to add entries to a blog. The community journaling system enables anyone (or members of a specified community) to post to blogs if the owner of the blog (e.g., a “blogger”) enables this feature. When a user sends an SMS message from a mobile device to an SMS computing device, the SMS computing device can post the message to a blog, such as by copying the text of the SMS message to an email message and sending the email message to a server component that converts text the email contains into a journal entry on a blog. In various embodiments, the SMS computing device may be able to retrieve from a storage (e.g., a database) the sender's name, such as by associating the sender's telephone number with the name in a database. In such cases, the SMS computing device may identify the sender by name when causing the text the sender sent to be posted to the blog. Alternatively, the sender may be identified by the telephone number or as an anonymous poster of the journal entry.

Publishers of digital content sometimes employ Rich Site Summary (“RSS”), which is also referred to as Really Simple Syndication, to publish digital content, including blogs. In various embodiments, the community journaling system provides an RSS-like mechanism that publishes blogs to users of the community journaling system. A computing device can collect blog entries, such as from blogs the user has specified an interest in, and periodically publish the blog entries by sending SMS messages containing the blog entries. As an example, the computing device may send the latest blog entry or the latest five blog entries and provide menu navigation commands that the user can use to receive additional blog entries, such as from the same or a different blog. The computing device can optionally filter the blog entries, such as based on the user's prior indications of one or more criteria. The computing device can filter blog entries based on the blog user (or mobile telephone number) that created the blog entry, text within the blog entry, the time of the blog entry, and so forth. As an example, a user may indicate to receive all blog entries made by a specified blogger. The user may thus filter which blog entries are received by optionally specifying criteria.

In some embodiments, the community journaling system enables users to invite others to a blog via SMS. A blogger can invite an SMS user to the blog by providing the invited user's mobile telephone number. The community journaling system can then send an SMS message that provides instructions for joining the blog; instructions for sending commands; a telephone number to which to send SMS messages containing commands; and so forth. The blogger can invite SMS users by employing a user interface on a Web page, by sending an SMS message, or using other means. As an example, the blogger can request an invitation message from the community journaling system and then forward the received invitation to others.

In various embodiments, the community journaling system recognizes commands sent via SMS by using a flexible syntax. When a user sends an SMS message to an SMS computing device, the community journaling system can employ a syntax checker component to check the commands so that an appropriate action can be taken based on the command. The following are examples of the syntax that the community journaling system may send when the user requests help, first sends a command via SMS (e.g., an incorrect command), or completes a registration process:
B—Post to your blog
N—Receive notifications of any new posts on your blog
N <mobile no./Logger name>—Receive notifications of new posts from the given mobile no./Logger on your blog
B <Spaces ID>—Post to a friend's blog
R—Read the latest post on your blog
R <Spaces ID>—Receive the latest post on someone else's blog
S <Spaces ID>—Subscribe to always receive the latest posts on someone else's blog
L <Spaces ID> <Logger name>—choose a Logger name that is associated with all your posts from this phone. You can always change this by sending the same syntax with your new username
S <Spaces ID> <mobile no./Logger name>—Subscribe to always receive posts from the given mobile no./Logger on this blog
Un <Spaces ID>—Unsubscribe from receiving the latest posts on someone else's blog
Un <Spaces ID> <mobile no./Logger name>—Unsubscribe from receiving posts from the given mobile no./Logger on this blog
I—Receive an invite that you can fwd to all your friends asking them to sign up for your blog (The SMS invite says: “Hi, I now have a community blog! U can post to it by SMSing ur msg to 0123456789. Start ur SMS with B ‘Space ID’. To know more send ? as an SMS.”)
E—Set up an event that is viewed/received as an SMS only by those on your MSN buddies list
?—To receive info on how to set up your own community blog
M—More options
   A Spaces ID is an identifier associated with a user at a specific blogging service's Web site, such as MSN.

The following are examples of features that the community journaling system may make available to users employing a Web interface to configure the community journaling system for their use:

1. Posting:
i. everyone can post to your blog via SMS
ii. only you can post to your blog via SMS
iii. your MSN buddies can post to your blog via SMS
iv. your approval is required for posting to your blog

2. Notifications:
i. Do you want to be notified every time there is a new post on your blog?
ii. Do you want to be notified every time specific users/ph. nos. post to your blog? (give us the username/ph. nos.)

3. Invitation action:

You can send out an invite to your friends by giving us their
i. ph. nos.
ii. email addresses

or by contacting those on your
iii. MSN buddies list

4. Unsubscribing:
i. Delete all SMS posts on the blog and bar anyone from SMS posting to your blog from now on
ii. Keep all previous SMS posts, but no one can post anything new from now on
iii. Bar specific ph. nos. from posting to your blog

The following are examples of features that the community journaling system may make available to users when sending SMS messages to an SMS computing device:

1. Scrapbook features:
i. Read a blog (you receive the two latest posts on the blog)—the number of blog entries may be specified by the user, or may be variably controlled by the SMS computing device
ii. Subscribe as reader to a blog (you receive every new post on that blog)
iii. Subscribe as Logger to a blog (you now have a username attached to any post that you make to the blog of your choice)
iv. Read posts from specific SMS blogger (receive posts from only a particular ph. no./Logger name that you provide)
v. Ban specific Loggers/mobile nos. from posting to your blog
vi. Receive notifications of all new posts on your blog
vii. Receive notifications for new posts from specific Loggers/mobile nos. to your blog
viii. Choose and change your Logger name
ix. Receive a template invite to send to all your friends
x. Receive info on how to set up a community SMSblog
xi. Event book (set up meetings and rendezvous with your MSN buddies—this is viewable only to the user's MSN buddies list)

2. Unsubscribing:
a. Reader
   i. general reader (you will no longer receive all new posts on the blog)
   ii. specific reader (you will no longer receive any new posts from the blogger that you specify)
b. Logger (you will no longer be registered on the blog and your username will not be associated with any post that you send from now on)

When a user registers at a Web site to enable SMS blogging, the community journaling system may provide the following features:

1. Give us your name, spaceid+mobile
a. We just sent you a key/password

2. Sign into your Spaces and select E-mail Publishing in the Options menu
a. Turn on E-mail Publishing
b. Copy in our email address in the box provided
c. Give yourself a secret name
d. Click Save

3. Give us your secret name in the box provided.

4. Great, you're done! You will now receive an SMS with all the cool SMSBlogging options you can use.

The following describes a possible user interaction flow when a user interacts with the community journaling system in various embodiments:

b 1. From a registered mobile phone, the user sends an SMS to the Blog Access Number provided by the SMS computing device.
a. Software executing on the SMS computing device checks the incoming SMS message to verify that it is from a registered mobile telephone number. It may use simple emailing to push the post to the registered blog with the name of the user (as given during the registration process) as the header for the post. If the SMS message is not from a registered mobile telephone number, it may return an SMS message (perhaps after a specified number of incoming SMS messages from that mobile telephone number) informing the user that the user can Subscribe and/or Register to the blog.

2. The message may be parsed by a component of the SMS computing device in the following manner:
a. The command (or “function”) syntax in an SMS message may be as follows: <function> <name of blog> <message to be posted>
b. Up to the first three words in the SMS message, <function> <name of blog> <mobile no./Logger name>, may be assumed to be the function the user chooses to use, the Spaces ID that the user wants to access or upload information to or the mobile number, or the Logger name that the user wants to subscribe or unsubscribe to. The following identifies some commands a user may send via SMS to the SMS computing device:
   i. X Soft I liked the movie
   If the <function> (“X”) is not found in the listed syntax by the syntax checker component, an SMS message may be sent to the sender asking her to choose a best match. E.g., “Reply with the number of the correct match: 1. Post to blog 2. read from blog 3. Set up event 4. more . . . ”
   ii. B Soft I liked the movie
   If the <function> (“B”) and the <space id> (“Soft”) are found in the listed syntax, the identified function may be executed and an SMS message may be sent back to the sender informing her that she has successfully achieved her task. E.g., “Thanks! Your message has now been posted on soft.spaces.live.com.” The space ID may be located in a database configured for use with the SMS computing device.
   iii. B Sad movies make me cry
   If the <function> (“B”) matches an existing syntax command, the mobile number is registered as an owner of a blog, and the SMS contains some text, the syntax checker component can carry out the given function on the linked blog and return a confirmation report once it has achieved the task. E.g., “Sad movies make me cry is posted on the senders blog.”
   iv. I
   If the <function> (“I”) matches an existing syntax command, the mobile number is registered as an owner of a blog, and the SMS contains no text, the syntax checker component can carry out the given function if allowed. E.g., only a registered user may receive the invite—“Hi, I now have a community blog! U can post to it by SMSing ur msg to 0123456789. Start ur SMS with B ‘Space ID’. To know more send? as an SMS.”
   v. S Soft 9880289621
   If the <function> (“S”) matches an existing syntax command, the <space id> (“Soft”) is registered, and the mobile number (“9880289621”) is registered, the syntax checker component can carry out the given function on the linked blog and return a confirmation report. E.g., “Thanks! U will now receive all posts at soft.spaces.live.com from 9880289621. Logger name—arc.”
   vi. S Soft 9844406380
   If the <function> (“S”) matches an existing syntax command, the <space id> (“Soft”) is registered and the mobile number (“9880289621”) is not registered, the syntax checker component can carry out the given function on the linked blog and return a confirmation report. E.g., “Thanks! U will now receive all posts at soft.spaces.live.com from 9844406380.”

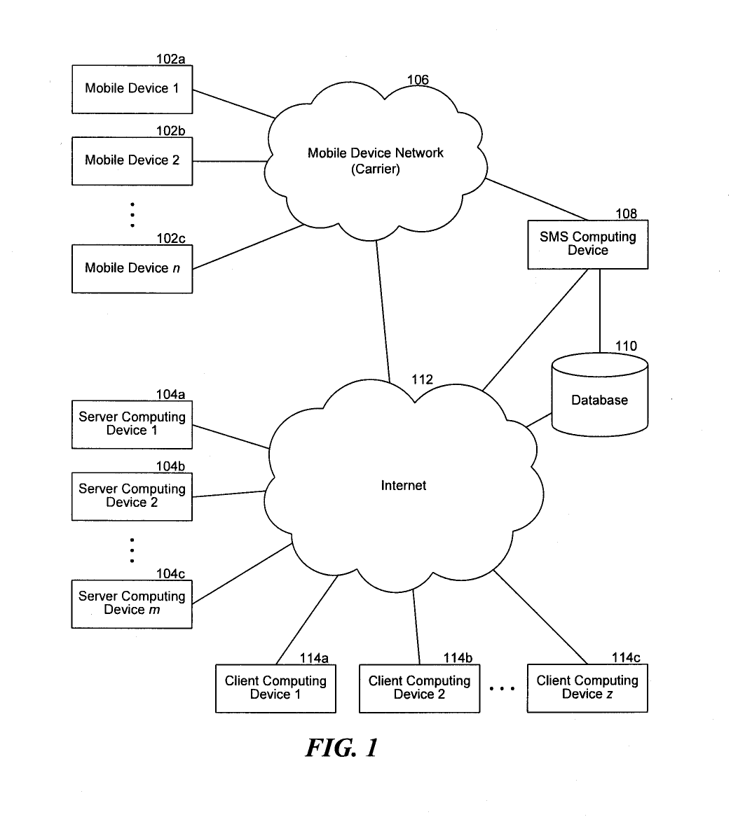

The community journaling system will now be described with reference to the figures. FIG. 1 is a block diagram illustrating an environment in which the community journaling system operates in some embodiments. The environment includes one or more mobile devices 102a, 102b, . . . 102c, such as mobile telephones. These mobile devices may communicate via a mobile device network 106, such as a mobile telephone carrier's network. This network may be connected to a data communications network 112, such as the Internet. Networks 106 and 112 may be connected to an SMS computing device 108 and a database component 110. The SMS computing device 108 and database component 110 may be interconnected. The SMS computing device may operate with a syntax checker component that checks syntax of incoming SMS messages and takes actions based on the messages. The network 112 may also be connected to one or more server computing devices 104a, 104b, . . . 104c, such as Web servers, blog servers, electronic mail servers, and so forth. The network 112 may also be connected with client computing devices 114a, 114b, . . . 114c, such as computing devices a user may employ to register to use the community journaling system via a Web interface. The community journaling system may also have a syntax checker and command handler component 116 that checks the syntax of incoming SMS messages to select an appropriate command and handles the selected command. In some embodiments, various components can be combined or split up. As an example, the syntax checker and command handler can be two separate components. The syntax checker, command handler, SMS computing device, and database can all be components of the community journaling system 118.

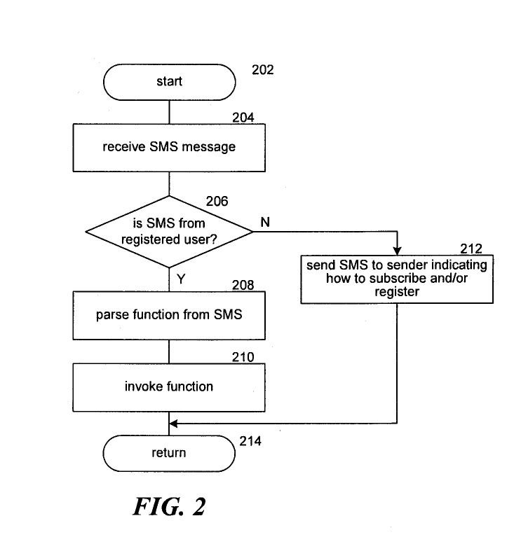

FIG. 2 is a flow diagram illustrating a routine invoked by a component of the community journaling system, such as the syntax checker component of the SMS computing device, in some embodiments. The routine begins at block 202. At block 204, the routine receives an SMS message, such as from a mobile phone user. At decision block 206, the routine determines whether the message is from a registered user. If the message is from a registered user, the routine continues at block 208. Otherwise, the routine continue at block 212, where it sends an SMS message to the sender indicating how to sub scribe and/or register. At block 208, the routine checks the syntax of the commands in the SMS message and parses the SMS message to identify a message contained in the SMS message. The message the SMS contains can include a command. Upon identifying the message, the routine invokes the indicated function at block 210. At block 214, the routine returns.

In various embodiments, the routines described herein can be modified in various ways. As examples, additional logic can be combined, some logic can be ignored, logic associated with the blocks can be performed in a different order than illustrated, and so forth.

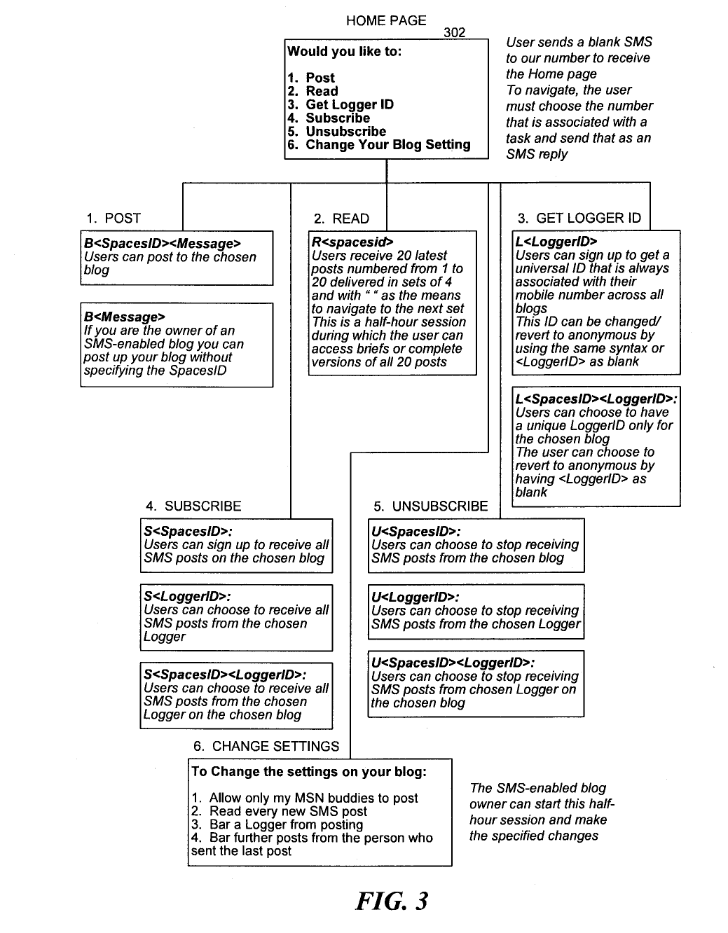

FIG. 3 is a flow diagram illustrating a navigation menu structure the community journaling system may send users, such as via SMS, in some embodiments. The figure illustrates commands and results. As an example, a user may initially receive a home page 302 when the user sends a blank SMS message to an identified phone number. The user can then provide a command, such as by sending an SMS message containing a “P” or “1” for post. In response, the community journaling system can provide command syntax, such as “B <spaces ID> <Message>” to explain how to post a log entry. The various commands and results are illustrated in FIG. 3.

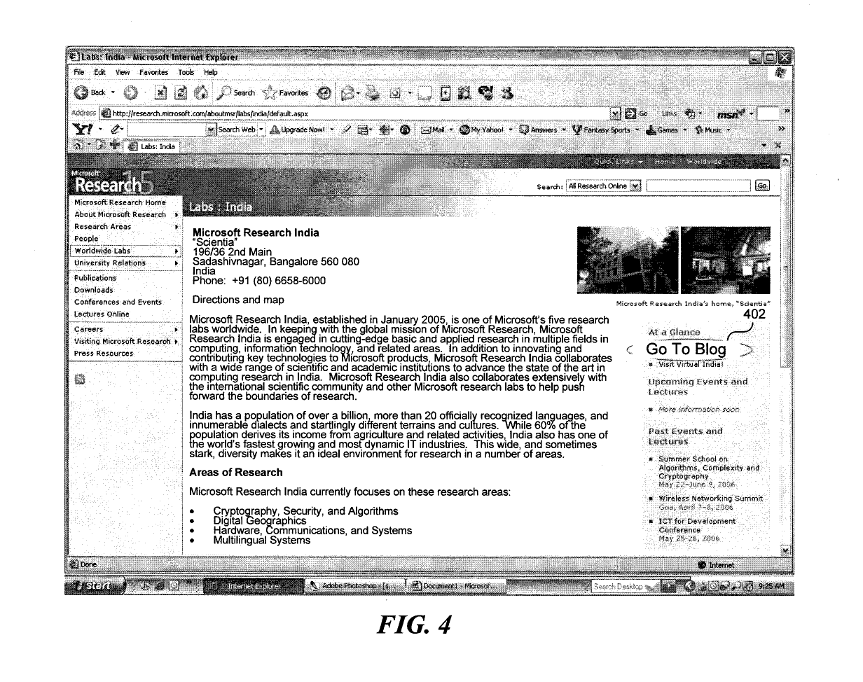

FIGS. 4-8 are user interface diagrams illustrating Web interfaces associated with the community journaling system in various embodiments.

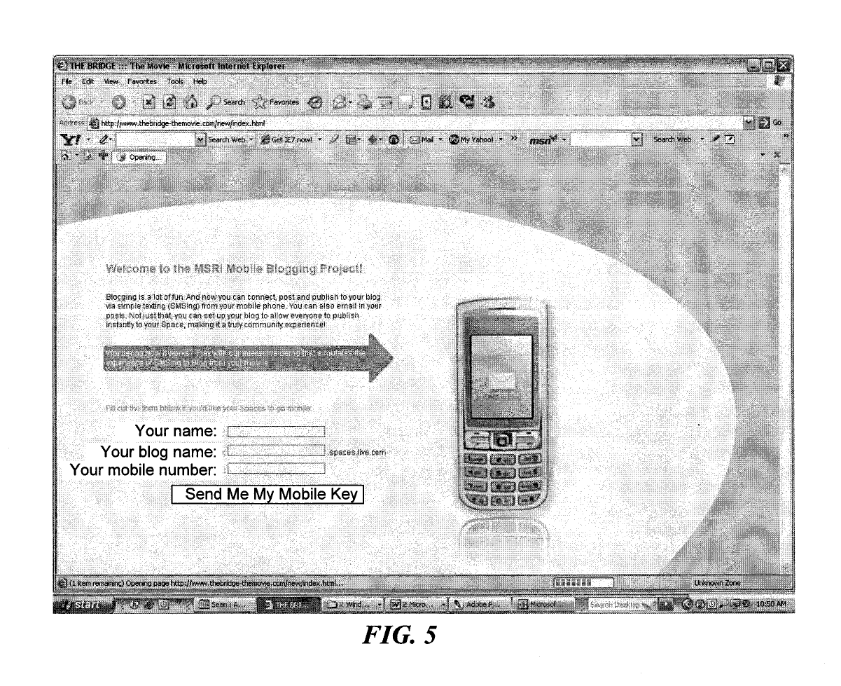

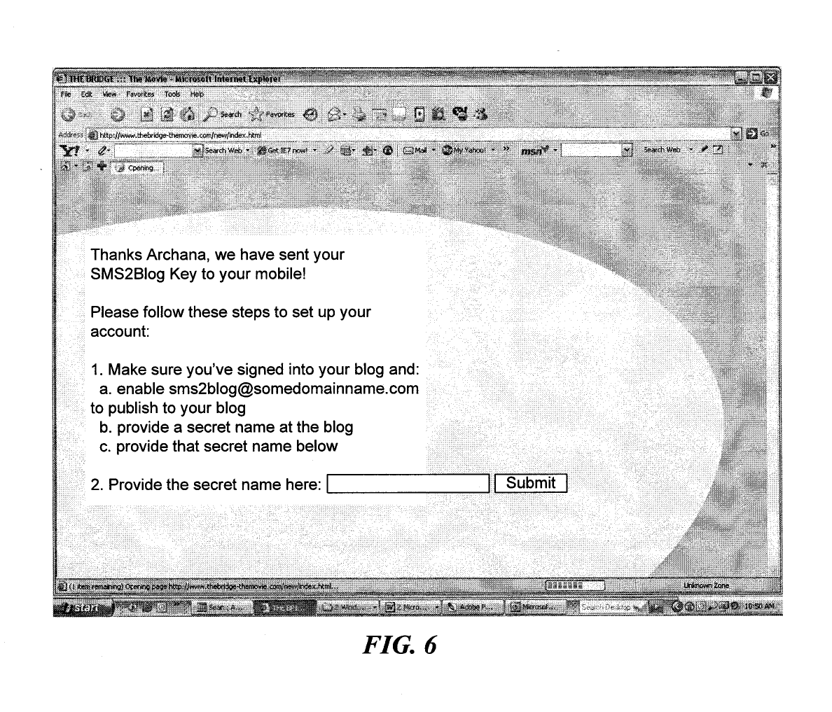

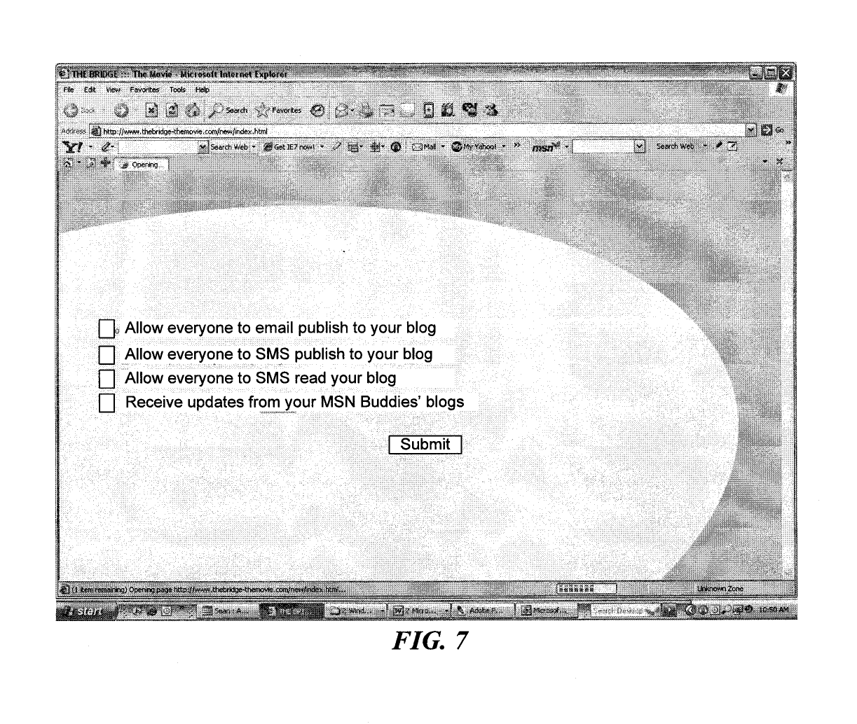

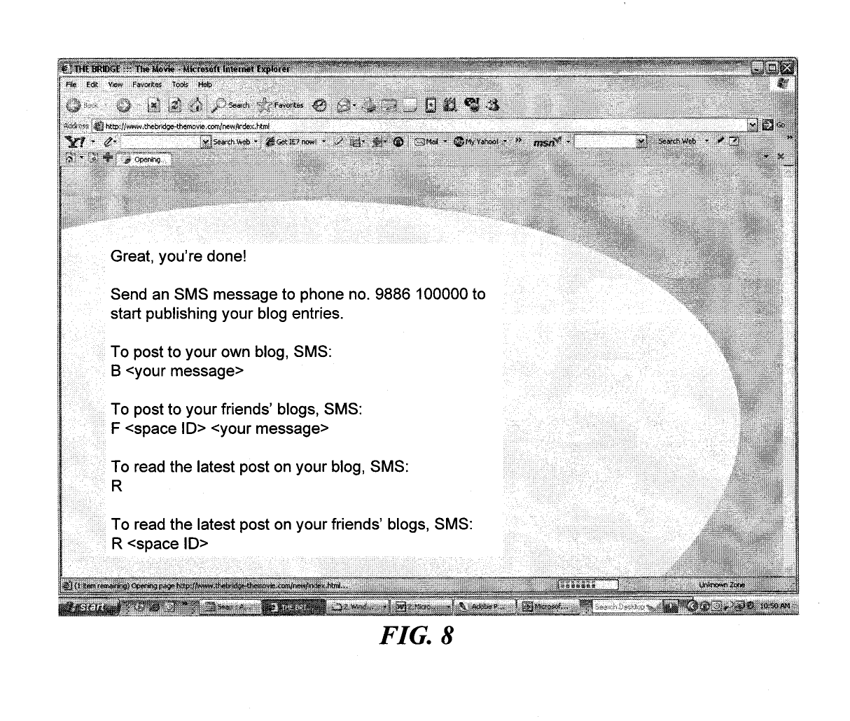

A user can navigate a Web browser to a home page and select a blogs link (FIG. 4, 402). The community journaling system can then provide a Web page that enables the user to provide a name, blog space name, and mobile telephone number (FIG. 5). The community journaling system can then send a “key” (e.g., a word) to the indicated mobile telephone number. The user may be prompted to return the key, such as via the mobile phone, to verify the user. The user can then enable the community journaling system's email address to post messages via email on the user's blog and provide a “secret name.” (FIG. 6.) The user can then provide various settings about who can post to or read from the blog. (FIG. 7.) For example, the user may be able to identify which users (e.g., by username, telephone number, etc.) can post to the blog or read entries in the blog. Thus, the community journaling system can verify whether a particular user or phone number is enabled for reading from or writing to a blog. The community journaling system can then provide instructions about posting to blogs. (FIG. 8.)

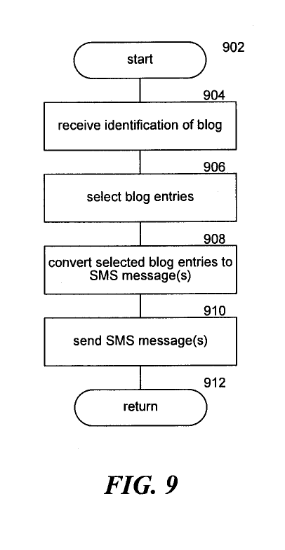

FIG. 9 is a flow diagram illustrating a routine invoked by a component of the community journaling system in some embodiments. The community journaling system invokes the routine 900 to provide a blog subscription to a user. As an example, the community journaling system may provide RSS-like blog updates to subscribers. The community journaling system may invoke the routine periodically, such as nightly, to send blog updates to subscribers. The routine begins at block 902. At block 904, the routine receives an indication of a blog. At block 906, the community journaling system may select blog entries, such as based on a filter subscribers identify. As examples, users can request all updates, a specified number of updates, updates made by specific users, updates containing identified text or other information, updates for specific blogs, and so forth. These settings may be stored in a database. The community journaling system may then convert the blog entries to one or more SMS messages at block 908. At block 910, the community journaling system sends the created SMS messages. At block 912, the routine returns.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a computer system for enabling community journaling, comprising:
receiving a message containing a journal entry and a command to post the journal entry to a journal;
identifying a sender of the received message;
determining whether the journal entry should be posted to the journal; and
when the journal entry should be posted to the journal,
converting the journal entry into a journal format that can be posted to the journal;
causing the converted journal entry to be posted to the journal; and
providing the identification of the sender in association with the posted journal entry.

2. The method of claim 1 wherein the message is in a short message service format and the journal format is an electronic mail message.

3. The method of claim 1 wherein the determining includes evaluating whether the sender has registered to be able to post entries to the journal.

4. The method of claim 1 wherein the determining includes evaluating whether the sender has been authorized by an owner of the journal to be able to post entries to the journal.

5. The method of claim 1 further comprising providing instructions to the sender when the journal entry should not be posted to the journal.

6. The method of claim 1 further comprising providing instructions to the sender when the sender could not be identified.

7. The method of claim 1 further comprising providing instructions to the sender when the sender sends an unrecognizable command.

8. The method of claim 1 further comprising interpreting a command contained by the message.

9. A system for enabling community journaling, comprising:
a mobile device capable of sending short message service messages; and
a community journaling system that receives a short message service message identifying a command, interprets the command, and takes an action in relation to the command and a journal.

10. The system of claim 9 wherein the command is to post a journal entry to the journal.

11. The system of claim 9 wherein the command is to receive a journal entry that has been posted to the journal.

12. The system of claim 9 further comprising a component that sends a journal entry that meets a criterion to a user.

13. The system of claim 12 wherein a criterion is an identity of a user that sent the journal entry.

14. The system of claim 12 wherein a criterion is an identity of the journal.

15. A computer-readable medium storing computer-executable instructions that, when executed, cause a computer system to perform a method of enabling community journaling, the method comprising:
selecting a journal;
periodically selecting journal entries in the journal, the journal entries stored in a first format;
converting the selected journal entries into a second format suitable for handling by a subscriber of the journal entries, the handling including displaying the journal entries on a screen of a mobile computing device; and
providing the converted journal entries to the subscriber for display.

16. The computer-readable medium of claim 15 wherein the method further comprises providing the converted journal entries in a short message service format.

17. The computer-readable medium of claim 15 wherein the method further comprises filtering the selected journal entries.

18. The computer-readable medium of claim 17 wherein the filtering includes checking a database indicating text that should be located in a journal entry.

19. The computer-readable medium of claim 15 wherein a journal entry is a blog entry.

20. The computer-readable medium of claim 19 wherein a selected number of blog entries are collected and sent periodically to a subscriber of the blog.
